(19) United States
(12) Patent Application Publication
(10) Pub. No.: US 2017/0367248 A1
(43) Pub. Date: Dec. 28, 2017

(54) GUIDE ELEMENT AND TOOL COMBINATION COMPRISING A GUIDE ELEMENT

(71) Applicant: Betek GmbH & Co.KG, Aichhalden (DE)

(72) Inventors: Wolfgang ESSIG, Rosenfeld (DE); Ulrich Kraemer, Wolfach (DE); Fabian Seifried, Herrenzimmern (DE); Florian Smeets, Dossenheim (DE)

(73) Assignee: Betek GmbH & Co.KG, Aichhalden (DE)

(21) Appl. No.: 15/594,993

(22) Filed: May 15, 2017

Related U.S. Application Data
(63) Continuation of application No. PCT/EP2015/076488, filed on Nov. 12, 2015.

(30) Foreign Application Priority Data
Nov. 13, 2014 (DE) 10 2014 116 619.1

(51) Int. Cl. A01B 15/02; A01B 23/00

(52) U.S. Cl. CPC A01B 15/02; A01B 23/00

(57) ABSTRACT

The invention relates to a guide element for an agricultural soil-cultivation machine comprising a connection region for arranging the guide element on a share tip, and comprising a first screw connection for attaching the guide element on a holder, in particular on a tine of the soil-cultivation machine. The guide element has varying thickness, at least in regions along the longitudinal extension thereof running from the connection region to a turned-away end region. The invention further relates to a corresponding tool combination comprising capacity of the guide element to be conformed to the loads in the tool insert, and thus conforming of the maintenance interval to that of the share tip.

### CROSS REFERENCE TO RELATED APPLICATIONS

This application is a continuation of International Application No. PCT/EP2015/076488 filed Nov. 12, 2015, which designated the United States, and claims the benefit under 35 USC §119(a)-(d) of German Application No. 10 2014 116 619.1 filed Nov. 13, 2014, the entireties of which are incorporated herein by reference.

### FIELD OF THE INVENTION

The present invention relates to a guide element for an agricultural soil-cultivation machine comprising a connection region for arranging the guide element on a share tip, and comprising a first screw connection for attaching the guide element on a holder, in particular, on a tine of the soil-cultivation machine.

The present invention further relates to a tool combination with a guide element and a share tip for an agricultural soil-cultivation machine, having a connection region of the guide element for arranging the guide element on a share tip, and having a first screw connection for attaching the guide element on a holder, in particular, on a tine of the soil-cultivation machine, wherein a thickness of the guide element in the connection region corresponds to a thickness of the share tip at its end, facing the guide element, within predefined tolerances.

### BACKGROUND OF THE INVENTION

DE 3628910 A1 discloses a tool combination, having a blade tip and a guide plate, which can be mounted together on a blade of a tine of a soil-cultivation machine. The share tip and the guide plate are connected together by a form-fitting connection, so that only one fastening screw is required for attaching the guide plate and the share tip to the blade. The form-fitting connection is formed by a tappet on the share tip, which engages with a corresponding recess in the guide plate. At its free end, the guide plate is bent around the blade to safely deflect the flow of soil from the blade at the upper free end of the guide plate and push it away in the intended direction. The bending achieves a form-fitting connection between the guide plate and the blade so that the guide plate can be attached to the blade with only one fastening screw.

A disadvantage of the disclosed tool combination is that the share tip, which is exposed to much heavier load than the guide plate during use, wears faster than the guide plate and, accordingly, must be replaced sooner. Due to the exposed form-fitting connection, deformations can be introduced in the area between the guide plate and the share tip during operation, preventing, or at least impeding, removal of the share tip from the guide element. This results in increased maintenance effort, during which a guide element that is not worn may have to be replaced. A further disadvantage arises from the fact that the guide element is more heavily stressed in its connection region to the share tip than at its free end. Replacement of the guide element is thus determined by its wear in the connection region, while the free end is still intact. The same applies to the share tip, which wears significantly faster at its front cutting edge than at its end facing the guide element. The tool combination shown, therefore, results in uneven wear behaviour of the components used with respect to each other and within the components. As a result, the most heavily stressed components or component portions determine the service life of the tool combination, and, thus, the maintenance intervals. During the required replacement, generally intact components or component portions must be replaced as well.

DE 10 2011 102 053 A1 discloses a tool combination having a share tip, which can be mounted on a tine of a soil-cultivation machine. The share tip is formed from a carrier part, the cutting end of which is equipped with a cutting element made of hard metal. On the side of the cutting element, secondary cutters are soldered to the carrier part at an angle. Adjacent to the carrier part, a guide plate is provided, which encloses the tine partially at its free end. A guide part is provided, which covers the carrier part with the exception of the cutting elements and secondary cutters. The guide part is connected to the guide plate in a form-fitting manner and is detachably connected to the carrier part. The multi-part construction makes it possible to replace only the functional components that are worn. The present document assumes that it is extremely unlikely that all functional components will become worn at the same time and, therefore, they must be replaced separately. This also applies to an embodiment of the present invention in which the guide plate and the guide part are designed as a single component. Here, the document provides a symmetrically constructed, and thus rotatable, guide plate so that the end facing the carrier part can be rotated when worn and continued to be used.

Here, too, there is the disadvantage that, due to the exposed form-fitting connection, deformations may be introduced in the region between the guide plate and the carrier part or the guide part, preventing, or at least impeding, separation of the components. This results in increased maintenance effort, during which components that are not worn may have to be replaced. Due to the different service life of the various functional components, frequent maintenance with associated downtimes of the soil-cultivation machine are required.

### SUMMARY OF THE INVENTION

It is an object of the present invention to provide a guide element of the aforementioned kind and a tool combination having such a guide element, resulting in reduced maintenance effort.

The object of the present invention with regard to the share tip is solved by the fact that the guide element has varying thickness, at least in regions along the longitudinal extension thereof running from the connection region to a turned-away end region. The thickness of the guide element in the various regions of the guide element can thus be adapted to the stress occurring there, and hence to the wear occurring there. Areas that are exposed to high stress are formed thicker than regions with lower stress. This ensures that the guide element has a comparable service life in all regions. With these measures, maintenance intervals can be extended, when compared to guide elements with consistent thickness, and comparable maintenance intervals can be achieved with reduced use of material. Furthermore, the change intervals of the guide element can be adapted to the change intervals of a connected share tip, significantly reducing the total required maintenance effort. A reduced use of materials advantageously results in reduced manufacturing costs and a reduction in weight of the guide element. In particular, if a plurality of guide elements is attached to the soil-cultivation machine, the weight reduction results in a reduction of the total stress on the soil-cultivation machine as well as of the fuel consumption of a drive unit of the soil-cultivation machine. The guide element may be manufactured, for example, as a forged part and thus be designed to be very strong and resistant to abrasion.

The mechanical stress of the guide element is greatest adjacent to the share tip. Therefore, it can be provided that the guide element has its greatest thickness in the connection region facing the share tip.

The mechanical stress, and thus the abrasion, of the guide element are lowest in its end region facing away from the share tip. In order to achieve a comparable service life between the connection region and the end region of the guide element, it can therefore be provided that the thickness of the guide element is smallest in its end region facing away from the share tip.

A comparable service life over the entire length of the guide element can be achieved by the thickness of the guide element decreasing continuously from the connection region to the end region.

According to a particularly preferred embodiment of the present invention, it can be provided that the thickness of the guide element in its connection region corresponds to the thickness of the share tip associated with the guide element at its end facing the guide element within predetermined tolerances. For the passing soil, this results in a continuous transition without pronounced steps where increased wear occurs. Furthermore, the same thickness of the guide element and of the share tip in their adjoining regions results in comparable service lives of the two components in these regions. If the remaining regions of the share tip and the guide element are adapted by means of corresponding thickness variations or, for example, by local coating with hard material elements, so that they have a service life comparable to the adjacent regions, the share tip and the guide element, as well as the components within themselves in the various regions, will have a comparable service life, and thus comparable maintenance intervals. The components can thus be replaced as the same time, resulting in reduced maintenance effort and reduced downtime of the soil-cultivation machine.

The guide element is mounted to the carrier with a first screw connection. A secure and wear-resistant first screw connection can be achieved by the first screw connection being arranged in the connection region of the guide element and/or by a first screw head of a first fastening screw of the first screw connection being arranged in a countersunk position relative to a deflecting surface of the guide element. Fastening of the guide element is thus done in the area of its greatest material thickness, resulting in a resilient connection between the guide element and the carrier. Due to the recessed screw head, it is protected from passing soil and thus from abrasive wear. The wear protection is further improved by the fact that soil sticks above the screw head in the screw receptacle and thus shields the screw head from the passing soil. Due to the present high material strength, the screw receptacle can be designed correspondingly deep. The screw head is therefore countersunk with respect to the deflection surface of the guide element, and thus protected against wear, even after severe abrasion of the guide element has taken place. The guide element is thus securely held on the carrier until replacement is required.

According to the present invention, it can be provided that the guide element can be constructed for its back side to be in contact with the carrier and/or that the guide element has protruding bridges on its back side, arranged spaced from each other, and/or that a guide receptacle for the carrier is formed between the bridges. By a rear contact of the guide element with the carrier, high resilience against deformation is achieved even in areas of reduced thickness of the guide element since forces applied to the guide element against a tool feed direction are transferred to the carrier. The lateral bridges allow for simple mounting of the guide element, since the guide element can be easily aligned with respect to the carrier due to the bridges and the guide receptacle. A further advantage of the bridges results from the fact that they absorb lateral loads on the guide plate during operation. The guide element is thus affixed on the carrier in a form-fitting manner, transversely to the tool feed direction.

The bridges can be advantageously arranged in the connection region and/or in the end region of the guide element. In these regions, the bridges accomplish the best possible lateral guiding of the guide element. Compared to longer bridges, for example, ones that are continuous from the connection region to the end region, there is an advantage in material optimization and, as a result, a correspondingly lower weight of the guide element with the same attainable level of lateral guiding.

Transverse forces acting on the guide element can be especially well absorbed due to the two bridges being arranged opposite of one another on both sides of the carrier and/or the bridges having drafts on their sides facing the carrier, such that their mutual distance increases with increasing distance from the back side of the guide element. The drafts facilitate mounting of the guide element to the carrier since the guide element aligns itself to the carrier. Due to the drafts, a guide receptacle is achieved that is widening outwards and into which the carrier can be easily inserted. The widening guide receptacle allows manufacturing the guide element by forging.

A rear support of the guide element in the region of the bridges may be achieved by the fact that a contact surface for contact of the guide element with the carrier is formed between the bridges and/or that clearances in the form of grooves are provided in the transition from the drafts to the contact surface. The clearances accommodate the edges of the carrier. This achieves a large area of contact of the contact surface of the guide element on the carrier even if the same has a manufacturing-related burr, for example, at the edges.

According to one embodiment of the present invention, it can be provided that the bridges have outer bridge surfaces on their side facing away from the guide element and that the transitions from the drafts to the outer bridge surfaces are rounded. The rounded transitions from the drafts to the outer bridge surfaces prevent tilting of the guide element with respect to the carrier during assembly. Due to the rounded transitions and the adjacent drafts, the guide element can be aligned simply on the carrier and can self-align. In addition, the rounded transitions result in a stress-optimized construction in which stress spikes, as occur in the area of sharp edges under mechanical load, can be avoided.

The guide element and an associated share tip can be aligned with each other, by the guide element having an attachment, in particular, a plug attachment, in the connection region for affixing it in a receptacle of the share tip.

According to a particularly preferred embodiment of the present invention, it may be provided in this case that the shape of the attachment of the guide element is designed such that it can be connected only with a share tip that is uniquely associated to it by a receptacle that is adapted to it in its shape. This achieves an encoding in the assignment of a guide element to a share tip, resulting in only an associated type of guide element being connectable to a certain design of a share tip. As a result of this measure, only those share tips and guide elements can be connected together that are matched to one another, for example, in their wear behaviour. For example, share tip types with different thickness may be provided where a type of guide element with matched thickness in the connection region is uniquely associated.

Such an encoding between the guide element and the share tip can be effected by the attachment of the leading element being equipped with at least one projection and/or at least one recess for cooperating with a receptacle and/or an attachment molded on the share tip.

In addition to the first screw connection, effective affixing on the guide element can be achieved by the attachment and the receptacle forming a form-fitting connection. The guide element with its attachment is thus held in the receptacle of the share tip in a form-fitting manner.

A possible embodiment of the present invention is characterized in that the guide element 30 is integrally formed on the share tip 40. This reduces the cost for parts and assembly. In addition, a homogenized flow of the crop material on the surface can be achieved.

One conceivable embodiment of the present invention can be designed such that the front side 32.1 of the guide element 30 forming the guide surface coils in the region between the end facing the share tip 40 and the end facing away from the share tip 40. This allows the crop flow to be directed to the side of the cultivator. In particular, this continuously targeted deflection may reduce the tractive force requirements. Here, not only the front, but, in particular, the entire guide element may be twisted or coiled. This reduces the parts cost. Preferably the guide element should be coiled in the range between 50° and 80°. Optimum deflection is achieved in the range between 15° and 70°.

The object of the present invention with regard to the tool combination is solved by the fact that the guide element has varying thickness, at least in regions along the longitudinal extension thereof running from the connection region to a turned-away end region. Due to the varying thickness, the resilience of the different regions of the guide element can be adapted to the respective loads present during use of the tool so that at least approximately equal service life is achieved over the entire longitudinal extension of the guide element. The guide element does therefore not have to be replaced prematurely because a particularly heavily stressed region is worn out prematurely. Due to the thickness of the guide element being locally adapted to its load, its service life can be adapted to the connected share tip so that the same replacement intervals are advantageously achieved for the guide element and the share tip.

An adjustment of the thickness of the guide element to the stress actually present during use of the tool can be achieved by the thickness of the guide element decreasing from the connection region toward an end region of the guide element, opposite the connection region.

According to a preferred embodiment of the present invention, it can be provided that the share tip has a receptacle, which is covered by a covering portion in the tool feed direction (V), that the guide element has an attachment, in particular a plug attachment, and that a connection, in particular a form-fitting connection, formed by a receptacle and an attachment engaging therewith, is effective in the region of the receptacle between the share tip and the guide element. Due to the form-fitting connection, the guide element is securely attached to the share tip and aligned with respect to the same. The covering portion prevents the region of the form-fitting connection from being directly exposed to the passing soil. The form-fitting connection is thus protected against abrasive wear. Furthermore, the attachment is held by the covering portion, so that it will not buckle under load. This achieves a much longer service life of the form-fitting connection compared to a form-fitting connection that is open in the tool feed direction. Due to the reduced wear of the attachment and the receptacle, the share tip and the guide element can be easily and reliably separated from each other even after high mechanical stress, keeping the maintenance effort when changing the guide element and/or the share tip low.

Unique assignment of a share tip to a guide element matched to it in terms of its wear can be achieved by selecting the shape of the attachment, in particular the plug attachment, depending on the thickness of the guide element in its end region, and the shape of the receptacle of the share tip depending on the thickness of the share tip at its end facing the guide element end, such that the attachment, in particular the plug attachment, and the receptacle are connectable only with identical thickness of the guide element in its connection region and of the share tip at its end facing the guide element. Due to the design of the receptacle and the attachment, only guide elements and share tips with identical thickness in their transition region will match each other. Due to this encoding, it can be ensured that only those guide elements can be assigned to the respective share tips for which the service life is accordingly matched to the service life of the share tips.

Preferably, it can be provided that the guide element along its longitudinal extension, preferably in its end region, or otherwise at any point on the front side 32.1. is concavely shaped in a tool feed direction (V) so that the share tip, along its longitudinal extension at least in a portion facing the guide element, is concavely shaped in the tool feed direction (V) and that the radii of the concavely shaped portions, at least in the connection region of the guide element and the portion of the share tip facing the guide element, are identical within manufacturing-related tolerances and/or that the concave portions transition into one another. A uniform passage of the soil from the share tip to the guide element is achieved without creating any areas of increased resistance, and thus abrasion.

The front side 32.1 of the guide element can have different designs within the scope of the present invention. Thus, it is possible that the front side 32.1 may be designed at least partially concave, convex, or corrugated. A concave geometry forms a channel in the longitudinal direction of the guide element for directional guiding of the material. With a convex design, the material is deflected to either side of the cultivator. This creates compression and expansion zones in the longitudinal direction of the guide element in favor of an improved wear behaviour. Here, corrugation can already offer a significant advantage. Instead of a concave or convex contour, attached surface geometries may be provided as well. A varying width of the guide element may be provided in the width direction as well in order to influence the conveying effect in a targeted manner.

### BRIEF DESCRIPTION OF THE DRAWINGS

The present invention is explained in further detail below on the basis of an embodiment shown in the figures.

FIG. 1 shows a front view of a cultivator share, having a blade tip and a guiding element;

FIG. 2 shows a detail of the cultivator share, shown in FIG. 1, in the region of the share tip and the guide element, in a lateral sectional view;

FIG. 3 shows the guide element with a tine in an end region of the guide element in a first embodiment in a sectional view extending in a direction transverse to the longitudinal extension of the guide element;

FIG. 4 shows the guide element and the tine in an end region of the guide element in a second embodiment in a sectional view extending in a direction transverse to the longitudinal extension of the guide element;

FIG. 5 shows the guide element and the tine in a connection region of the guide element in a first embodiment in a sectional view extending in a direction transverse to the longitudinal extension of the guide element;

FIG. 6 shows the guide element and the tine in a connection region of the guide element in a second embodiment in a sectional view extending in a direction transverse to the longitudinal extension of the guide element;

FIG. 7 shows a detail of the lateral sectional view, shown in FIG. 2, in the region of a form-fitting connection;

FIG. 8 shows the section of the form-fitting connection, shown in FIG. 7, in a partially sectioned rear view;

FIG. 9 shows the detail, shown in FIG. 7, in a second embodiment of the form-fitting connection;

FIG. 10 shows the section, shown in FIG. 9, in a partially sectioned rear view; and

FIG. 11 shows the detail, shown in FIGS. 8 and 10, in a third embodiment of the form-fitting connection.

### DETAILED DESCRIPTION OF THE INVENTION

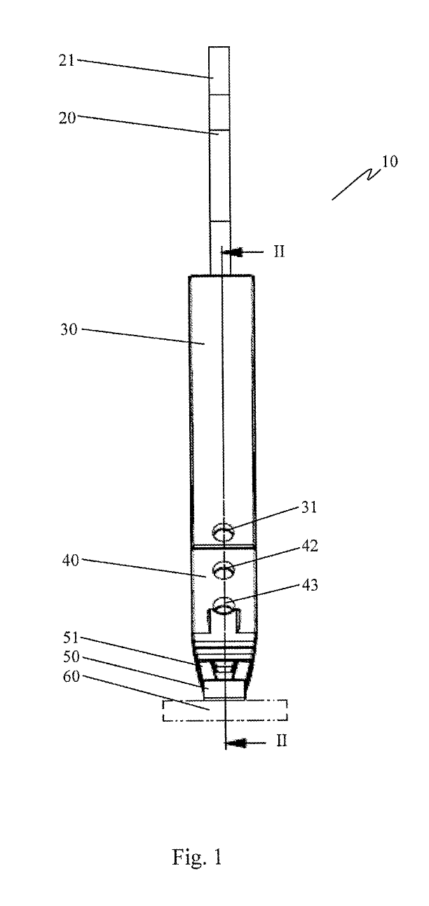

FIG. 1 shows a front view of a cultivator share 10, having a blade tip 40 and a guide element 30. The cultivator share 10 can be attached to a tool carrier, in particular, a tine 20 or tine carrier or plow beam or the like of an agricultural soil-working machine. For this purpose, the guide element 30 has a first screw receptacle 31 and the share tip 40 has a second screw receptacle 42 and a third screw receptacle 43. The tine 20 has a fastening part 21, not shown, which is pierced by fastening bores. By means of these fastening bores, the tine 20 can be mounted on a device carrier. On the side facing the soil 60 to be cultivated, the share tip 30 ends in two front cutting elements 50, with which two hard material elements 51 are associated on the side.

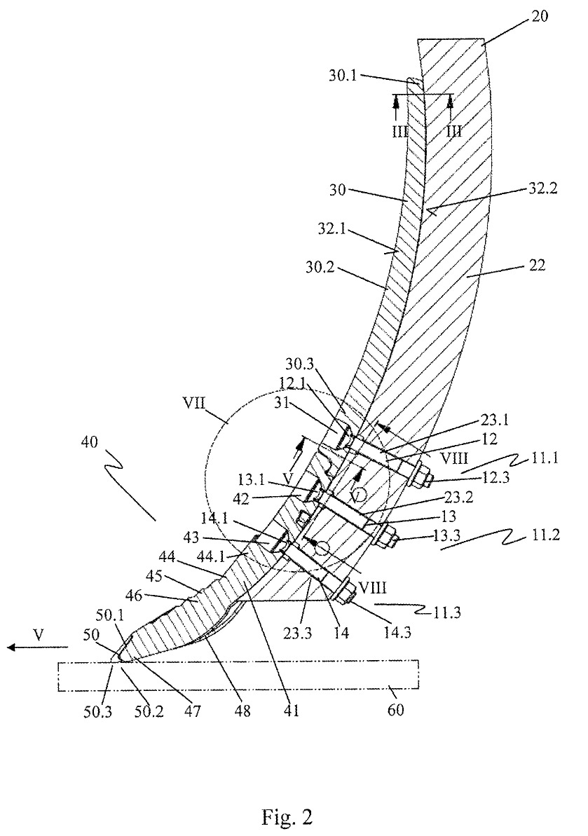

FIG. 2 shows a detail of the cultivator share 10, shown in FIG. 1, in the region of the share tip 40 and the guide element 30, in a lateral sectional view. The section in this case runs along the cutting line indicated by II in FIG. 1.

The tine 20 has a carrier part 21, shown in FIG. 1, in a region facing away from the carrier part 22. The share tip 40 and the guide element 30 are mounted on this carrier part 22.

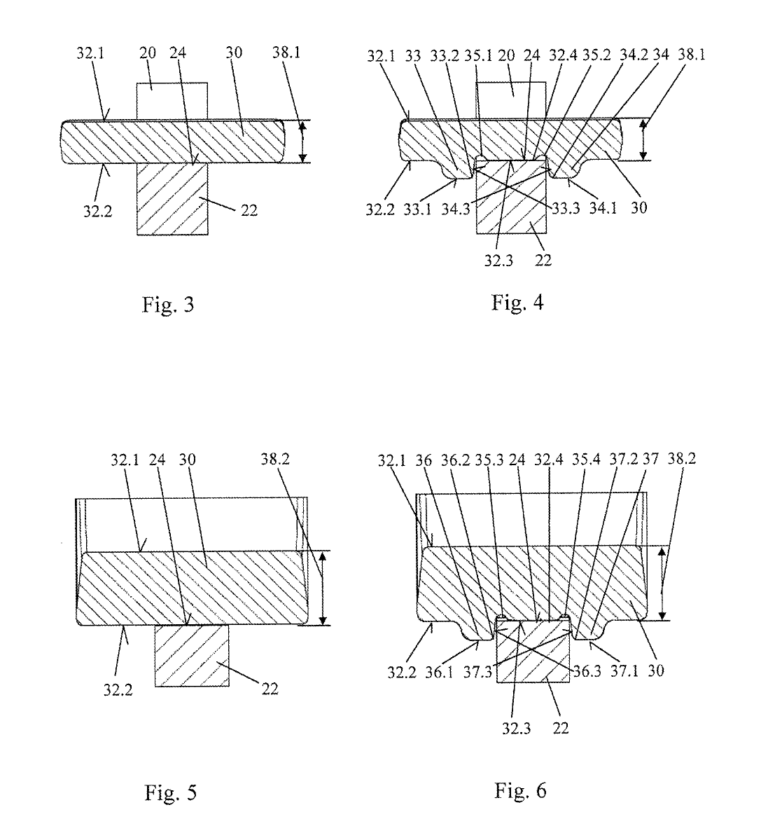

The guide element 30 is aligned with a deflecting surface 32.1 toward the tool feed direction V. The guide element 30 abuts against the carrier part 22 of the tine 20 with a back side 32.2. The guide element 30 is concavely curved in the tool feed direction V, starting from a connection region 30.3 facing the share tip 40, via a central region 30.2, to an end region 30.1 facing away from the share tip 40. In this case, the thickness 38.1, 38.2, of the guide element 30, indicated by double arrows in FIGS. 3 to 6, continuously decreases from the connection region 30.3 to the end region 30.1.

The carrier part 22 of the tine 20 has a first bore 23.1, a second bore 23.2, and a third bore 23.3 for fastening the guide element 30 and the blade tip 40. The first bore 23.1 is arranged flush with the first screw receptacle 31 mounted in the guide element 30. The guide element 30 is mounted to the carrier part 22 above the share tip 40 with a first fastening screw 12, which is inserted through the first screw receptacle 31 of the guide element 30 and the first bore 23.1 in the tine 20, as well as with an associated upper screw nut 12.3. A first screw head 12.1 of the upper fastening screw 12 is designed as a countersunk head and fits into the first screw receptacle 31, designed as a countersunk bore, such that the surface of the upper screw head 12.1 is arranged set back from the deflecting surface 32.1 of the guide element 30. The upper screw head 12.1 is thus protected against abrasive wear caused by the passing soil.

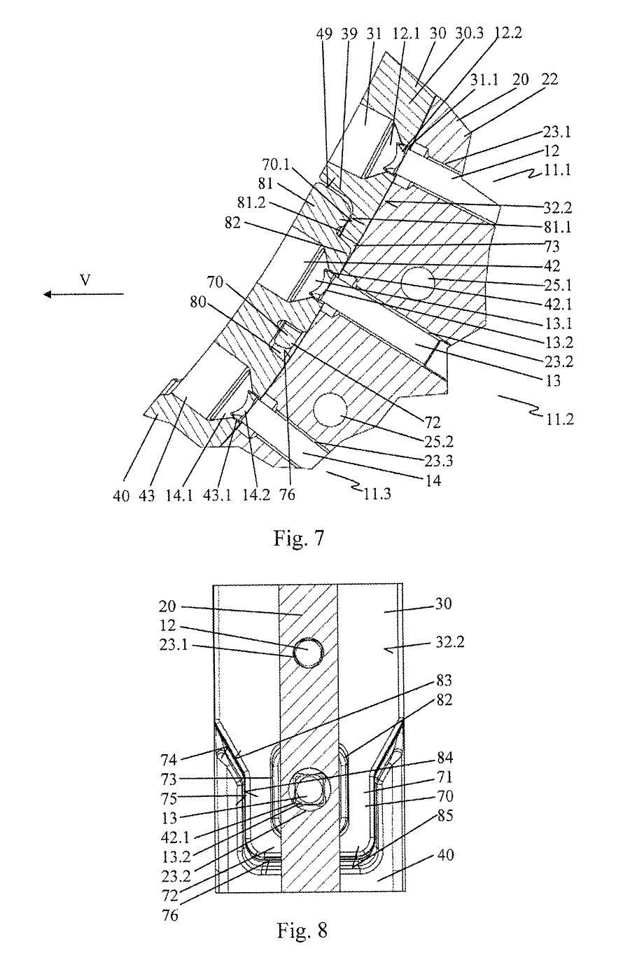

The share tip 40 is arranged adjacent to the connection region 30.3 of the guide element 30 and connected thereto by a form-fitting connection, more clearly shown in FIGS. 7 and 8.

The share tip 40 has a base part 41 which is penetrated by the second and third screw receptacle 42, 43. A deflector 44.1 is provided in the form of a projection below the third screw receptacle 43, protruding in the form of a deflector over a front-side deflecting surface 44 of the base part 41. In this manner, the deflector 44.1 forms a skirt that protects a third screw head 14.1 arranged in the third screw receptacle 33 of a third fastening screw 14 against the abrasive attack by the passing soil. In front of the deflector 44.1 in the tool feed direction V, the base part 41 has steps 45 which protrude over the deflecting surface 44. In the present exemplary embodiment, the attachments 35 are rib-shaped and oriented transversely with respect to the tool feed direction V. Depressions 46 are formed between the individual steps 45. During use of the tool, the soil may compress and settle into the region of the depressions 46. This forms a kind of natural wear protection on the front-side deflecting surface 44.

In front of the steps 45 in the tool feed direction V, the front cutting elements 47 are attached to a cutting element 50 in the form of hard metal elements, which form a cutter 50.3 as the front edge of the share tip 40. The cutting elements 50 have a flat-shaped mounting portion 50.1 and an attachment piece 50.2, integrally molded thereon and projecting against the tool feed direction V. The cutter 50.3 is formed in the region of the attachment piece 50.2. The cutting elements 50 are attached to the cutter carrier 47 such that the free terminating edge of the cutter carrier 47 is at least partially surrounded by the attachment pieces 50.2 of the cutting elements 50. In this manner, the free end of the cutter carrier 47 is protected against wear.

Behind the cutting elements 50 in the tool feed direction V, the hard material elements 51, shown in FIG. 1, are applied on the edge regions of the base part 41, which are subjected to particularly high wear. In the present case, hard metal plates are soldered to the base part 41 as the hard material elements 51. However, it is also conceivable to use an armor welding or the like. Opposite the hard material elements 51, the base part 41 is reinforced by projections 48 extending along its edges.

The second screw receptacle 42 and the third screw receptacle 43 of the share tip 40 are aligned flush with the second bore 23.2 and aligned third bore 23.3. Inserted through the second screw receptacle 42 and the second bore 23.2, there is a second fastening screw 13, held by a second screw nut 13.3. A second screw head 13.1 is countersunk and thus held in the second screw receptacle 42, protected against abrasive wear. The third fastening screw 14 is inserted through the third screw receptacle 43 and the third bore 23 and held by a third screw nut 14.3. The guide element 30 is thus mounted to the carrier part 22 of the tine 20 by a first screw connection 11.1, and the share tip 40 by a second and a third screw connection 11.2, 11.3.

The cultivator share 10 is pulled through the soil 60 to be cultivated by the agricultural soil cultivation machine along the illustrated tool feed direction V. Here, the soil is removed from the cutting elements 50 and deflected away over the front-side deflecting surface 44 of the share tip 40 and the adjacent deflecting surface 32.1 of the guide element 30. In the embodiment shown, the guide element 30 is designed straight, transverse to the tool feed direction V. In some cases, helical deflecting surfaces are used as well. The share tip 40 and the guide element 30 are concave along their longitudinal extension in the tool feed direction V. The radius of the front-side deflecting surface 44 of the share tip 40 in the transition region to the guide element 30 corresponds to the radius of the deflecting surface 32.1 in the connection region 30.3 of the guide element 30. Removed soil can thus be guided away from the share tip 40 via the guide element 30 in a flowing movement.

According to the present invention, the thickness 38.1, 38.2, of the guide element 30 varies over its longitudinal extension. It has the greatest thickness 38.2 in the connection region 30.3, which is adapted to the thickness of the adjacent share tip 40 in its region facing the guide element 30. Thus, there is a continuous transition from the front-side deflecting surface 44 of the share tip 40 to the deflecting surface 32.1 of the guide element 30. The soil can thereby be guided uniformly from the share tip 40 to the guide element 30. Open edges, on which the passing soil is caught, are avoided, resulting in a significant reduction of abrasion, and thus wear, in this region.

The mechanical stress on the cultivator share 10 decreases, starting from the cutting elements 50 to the end region 30.1 of the guide element 30. The most heavily stressed area of the cultivator share 10 is protected by the cutting elements 50, formed of a hard material, and the adjacent hard material elements 51. The adjoining region of the share tip 40 is designed particularly thick and is additionally protected against abrasion by the steps 45 and depressions 46. The deflector 44.1 forms a protection of the adjacent attachment region of the share tip 40 by deflecting the passing soil. The share tip 40 is therefore designed in accordance with the different loads occurring along its longitudinal extension such that a similar service life during operation of the various regions of the share tip 40 is achieved.

The guide element 30 is most highly stressed in the connection region 30.3 adjacent to the share tip 40, whereas the load decreases from the central region 30.2 towards the end region 30.1. Accordingly, the guide element 30 is designed such that it has its greatest thickness 38.2 in the connection region 30.3. The thickness 38.1, 38.2, of the guide element 30 decreases in accordance with the mechanical stress at the tool insert, over the central region 30.2, to its smallest thickness 38.1 in the end region 30.1. In operation of the cultivator share 10, uniform service life of the various regions of the guide element 30 is thus achieved. Due to the identical thickness 38.1, 38.2 of the guide element 30 and the share tip 40 in their transition region, it is achieved that the service life of the guide element 30 and the share tip 40 are at least approximately equal as well. Thus, it follows that the guide element 30 and the share tip 40 can be replaced at the same time, resulting in a significant reduction in maintenance work, and consequently downtime of soil-cultivation machine.

In known guide elements 30, in which the local material thickness is not adapted to the respectively present load, the thickness of the material is chosen such that the service life in the most heavily stressed region corresponds to the expected values. There is thus an unnecessarily large material thickness in less heavily stressed regions. This can be avoided by the thickness that, according to the present invention, is adapted to the expected load. Compared to known guide elements 30, the material used can be decreased with identical or even extended service life of the guide element 30. Manufacturing costs can thus be reduced. Furthermore, the weight of the cultivator share 10 is reduced, resulting in a reduction in the load on the soil-cultivation machine as well as in fuel consumption, in particular, if a plurality of cultivator shares 10 are attached to the soil-cultivation machine.

The guide element 30 is attached in the connection region 30.3, and therefore in the region of the greatest thickness 38.2 of the guide element 30 by means of the first screw connection 11.1. The great material thickness in this area allows for a particularly sturdy connection between the guide element 30 and the tine 20. The first screw receptacle 31 may be designed accordingly deep so that the first screw head 12.1 of the first fixing screw 12 is positioned far below the deflecting surface 32.1 of the guide element 30. In the cavity of the first screw receptacle 31 located above the first screw head 12.1, soil may settle and thus further protect the screw head 12.1 from passing soil during operation. The first screw head 12.1 is thus optimally protected against wear.

FIG. 3 shows the guide element 30 with a tine 20 in an end region 30.1 of the guide element 30 in a first embodiment in a sectional view extending in a direction transverse to the longitudinal extension of the guide element 30. The section in this case runs along the cutting line indicated by III in FIG. 2.

The guide element 30 abuts on a front side 24 of the carrier part 22 of the tine 20 with its back side 32.2, designed as a flat surface. A surface normal of the deflecting surface 32.1 points approximately in the tool feed direction V of the cultivator share 10. The removed soil pushes the guide element 30 against the front side 24 of the carrier part 22 so that the forces occurring are absorbed by the tine 20.

The guide element 30 has its smallest thickness 38.1 in the illustrated end region 30.1, which is mechanical least stressed.

FIG. 4 shows the guide element 30 and the tine 20 in an end region 30.1 of the guide element 30 in a second embodiment in a sectional view extending in a direction transverse to the longitudinal extension of the guide element. The section extends along the same section line as that in FIG. 3.

Unlike in the embodiment shown in FIG. 3, a first crosspiece 33 and second crosspiece 34 are molded to the side of the carrier part 22 of the tine 20 on the back side 32.2 of the guide element 30. As a result, a guide receptacle 32.4 for the carrier part 22 is formed between the crosspieces 33, 34. The crosspieces 33, 34, protrude over the back side 32.2 of the guide element 30 and each form an outer crosspiece surface 33.1, 34.1. The outer crosspiece surfaces 33.1, 34.1 transition into the rounded drafts 33.3, 34.3 via radial transitions 33.2, 34.2. The drafts 33.3, 34.3 are transitioned as clearances 35.1, 35.2, designed as grooves, into a contact surface 32.3, which is disposed in the same plane as the back side 32.2 of the guide element 30. The guide element 30 abuts on a front side 24 of the carrier part 22 of the tine 20 with its contact surface 32.3. The drafts 33.3, 34.3, are oriented such that their distance increases outwardly, starting from their transition to the contact surface 32.3.

In the direction of the longitudinal extension of the guide element 30, the crosspieces 33, 34, are limited to the end region 30.1 of the guide element 30.

The guide element 30 is disposed laterally to the carrier part 22 of the tine 20 in the guide receptacle 32.4. This allows for accurate and quick alignment of the guide element 30 with respect to the tine 20 during assembly. When tightening the first screw connection 11.1 during assembly, the guide element 30 is secured against rotation by the crosspieces. The same is true when releasing the guide element 30, significantly facilitating the assembly and disassembly of the guide element 30. During operation, transverse forces transferred to the guide element 30 are transferred to the carrier part 22 of the tine 20 by the crosspieces 33, 34, and thus absorbed. Deformations of the guide part 30, in particular in its end region 30.1 of reduced thickness 38.1, 38.2, can thus be avoided. The attachment of the crosspieces 33, 34, in the end region 30.1 of the guide element 30 results in a maximum Possible lever with respect to the first screw connection 11.1. Thereby, torques transferred to the guide element 30 due to lateral forces can be absorbed with the least possible force, and hence least possible load on the crosspieces 33, 34.

By means of the drafts 33.3, 34.3, of the crosspieces 33, 34, it is achieved that the guide element 30 can be positioned easily on the carrier part 22 of the tine 20 and will self-align during assembly. Furthermore, the drafts 33.3, 34.3, when compared to plane-parallel contact surfaces, reduce the risk of soil jamming between the carrier part 22 and the crosspieces 33, 34, and hindering disassembly of the guide element 30. The clearances 35.1, 35.2, accommodate the edges of the carrier part 22. This ensures that the guide element 30 abuts with its entire abutment surface 32.3 on the front side 24 of the carrier part 22 even if there are manufacturing tolerances or a manufacturing-related burr on the edges of the carrier part 22.

FIG. 5 shows the guide element 30 and the tine 20 in a connection region 30.3 of the guide element 30 in a first embodiment in a sectional view extending in a direction transverse to the longitudinal extension of the guide element. The section runs along the cutting line indicated by V in FIG. 2.

The guide element 30 thus also abuts on a front side 24 of the carrier part 22 of the tine 20 with its back side 32.3 in a connection region 30.3 facing the tine 20. In the illustrated embodiment, the back side 32.3 is designed flat transversely to the longitudinal extension of the guide element 30. The guide element 30, designed as shown in FIG. 5 in its connection region, may be designed as shown in FIG. 3 in its opposite end region 30.1 or, in accordance with the embodiment shown in FIG. 4, with crosspieces 33, 34.

Compared to the smallest thickness 38.1 in the end region 30.1 of the guide element 30 shown in FIGS. 3 and 4, the greatest thickness 38.2 of the guide element 30 is provided in the connection region 30.3, as indicated by the different lengths of the double arrows. Thus, in the region of the greatest mechanical load, and therefore the greatest abrasion of the guide element 30, the thickness 38.2 is greatest while the smallest thickness 38.1 is provided in the area of the lowest mechanical load and least abrasion.

FIG. 6 shows the guide element 30 and the tine 20 in a connection region 30.3 of the guide element 30 in a first embodiment in a sectional view extending in a direction transverse to the longitudinal extension of the guide element. The course of the section corresponds to that in FIG. 5.

As already described in FIG. 4 for the end region 30.1 of the guide element 30, crosspieces 36, 37, are provided in the connection region 30.3 of the guide element 30, to the side of the carrier 22 of the tine 20, in the embodiment shown in FIG. 6. A guide receptacle 32.4 for the carrier part 22 is formed between the crosspieces 36, 37. The crosspieces 36, 37, have outer crosspiece surfaces 36.1, 37.1, which transition into obliquely tapering drafts 36.3, 37.3, via rounded transitions 36.2, 37.2. The drafts 36.3, 37.3 are transitioned into the contact surface 32.3, extending in a plane to the back side 32.2 of the guide element 30, via clearances 35.3, 35.4.

The function of the crosspieces 36, 37, with their radial transitions 36.2, 37.2, drafts 36.3, 37.3, and 35.3, and clearances 35.4, corresponds to the function described for the end region 30.1 in FIG. 4. Again, there is lateral guiding of the guide element 30 in the guide receptacle 32.4 on the carrier part 22 of the tine 20, along with the described advantages. The guide element 30, designed as shown in FIG. 6 in its connection region, may be designed as shown in FIG. 3 in its opposite end region 30.1 or, in accordance with the embodiment shown in FIG. 4, with crosspieces 33, 34. If the guide element 30 is designed with crosspieces 33, 34, 36, 37, in both, its end region 30.1, as shown in FIG. 4, and in its end region 30.3, as shown in FIG. 6, high transverse forces acting on the guide element 30 can be absorbed. By means of the crosspieces 36, 37, in the connecting region, mounting of the guide element 30 on the carrier part 22 of the tine 20 is significantly facilitated since the guide element 30 aligns itself laterally relative to the carrier part 22 due to the crosspieces 36, 37, so that the first screw receptacle 31 is flush with the first bore 23.1.

As already described with reference to FIG. 5, the greatest thickness 38.2 of the guide element 30, indicated by a double arrow, is provided in the connection region 30.3, which continuously decreases over the central region 30.2 toward the end region 30.1 of the guide element 30.

FIG. 7 shows a detail of the lateral sectional view, shown in FIG. 2, in the region of a form-fitting connection. The section shown is indicated by a circle labeled VII in FIG. 2. The same components are designated as already described for FIGS. 1 and 2.

The guide element 30 has a first plug attachment 70 which is molded on as an extension of the guide element 30 at its connection region 30.3. The first plug attachment 70 is reduced in thickness when compared to the connection region 30.3 and arranged such that it forms a continuous back side 32.2 with the other regions of the guide element 30, with the first plug attachment 70 abutting against the carrier part 22 of the tine 20. The first plug attachment 70 is formed as a planar element with a recess 73. At its free end, the first plug attachment 70 is terminated by a bridge 72 with a rounded front edge 76, sloping down towards the tine 20 in the direction of the connection region 30.3 of the guide element 30.

At its end facing the guide element 30, the share tip 40 has a first receptacle 80, which is covered by a first covering portion 81 in the tool feed direction V. The first plug attachment 70 is held in the first receptacle 80 by a form-fitting connection. For this purpose, a molded-on attachment 82 is provided on a bottom side 81.1 of the first covering portion 81 facing the receptacle 80. The molded-on attachment 82 is formed such that it is fitted into the recess 73 of the first plug attachment 70 in a form-fitting manner. The second fastening screw 13 is inserted through the molded-on attachment 82.

The first covering portion 81 abuts on a top side 70.1 of the first plug attachment 70 with its bottom side 81.1. In the transition from the bottom side 81.1 to the molded-on attachment 82, a clearance groove 81.2 is provided circumferentially to the molded-on attachment 82, in which the edges of the first plug attachment 70, extending circumferentially around the recess 73 are accommodated.

Extending from the first plug attachment 73, the guide element 30 has a front surface 39 which is arranged at a small distance from a terminating edge 49 of the share tip 40.

One locking attachment 12.2, 13.2, 14.2, each is molded on the fastening screws 12, 13, 14, adjacent to their screw head 12.1, 13.1, 14.1. The locking attachments 12.2, 13.2, 14.2, engage with screw locks 31.1, 42.1, 43.1, which are provided on the respective screw receptacles 31, 42, 43, facing the carrier part 22. The fastening screws 12, 13, 14, are thus secured against rotation.

The carrier part 22 has bores 25.1, 25.2, extending transversely to the tool feed direction V, to which optional blade wing, not shown, may be bolted.

To assemble the cultivator share 10, the guide element 30 is so aligned to the tines such that its first screw receptacle 31 is flush with the first bore 23.1 in the carrier part 22 of the tine 20. Next, the first fastening screw 12 is inserted through the first screw receptacle 31 and the first bore 23.1 bolted to the tine 20 on the rear, using the first screw nut 12.3, as shown in FIG. 2. In this case, the first fastening screw 12 is secured against rotation by the first locking attachment 12.2 in the first screw lock 31.1 so that no tools are required on the side of the first screw head 12.1 for tightening. The guide element 30 is thus affixed to the carrier part 22 of the tine 20 by the first screw connection 11.1 that is formed.

In a second assembly step, the share tip 40 is placed against the carrier part 22 of the tine 20 such that the molded-on attachment 82 of the first receptacle 80 engages with the recess 73 of the first plug attachment 70 of the guide element 30. The share tip 40 is thus oriented with respect to the carrier part 22 so that the second screw receptacle 42 of the share tip 40 is flush with the second bore 23.2 of the carrier part 22 and the third screw receptacle 43 of the share tip 40 is flush with the third bore 23.3 of the carrier part 22. Again, the second and third fastening screw 13, 14, are inserted and bolted on the rear. The fastening screws 13, 14, are thus secured against rotation by their locking attachments 13.2, 14.2, in the screw locks 42.1, 43.1 of the screw receptacle 42, 43, so that the rear screw nuts 13.3, 14.3, can be tightened. The share tip 40 is mounted on the carrier part 22 of the tine 20 by means of the thus formed second and third screw connection 11.2, 11.3.

The molded-on attachment 82 of the first receptacle 80 and the recess 73 of the first plug attachment 70 form a form-fitting connection which blocks a movement of the guide element 30 out of the first receptacle 80, in addition to the screw connections 11.1, 11.2, 11.3. In the tool feed direction V, movement of the guide element 30 is blocked by the abutment of the first plug attachment 70 with its top side 70.1 at the bottom side 81.1 of the first covering portion 81. The guide element 30 is thus affixed in the first receptacle 80 of the share tip 40 in a form-fitting manner. The form-fitting connection is protected from passing soil by the first covering portion 81. Damage to the form-fitting connection, for example, by deformation of the first plug attachment 70, can thus be safely avoided. The share tip 40 and the guide element 30 can therefore be separated easily and quickly even after a long operating time with high wear. This is also facilitated by the small distance between the front surface 39 of the guide element 30 and the terminating edge 49 of the share tip 40, assuring that no large quantity of soil enters in the region of the form-fitting connection. By means of the second screw connection 11.2, the share tip 40 and the guide element 30 are firmly pressed together and held in this position in the region of the first receptacle 80 and the first plug attachment 70. Thus, bending open of the first covering portion 81 and the first plug attachment 70 is avoided. This also ensures that the share tip 40 and the guide element 30 can be separated simply and safely even after heavy use.

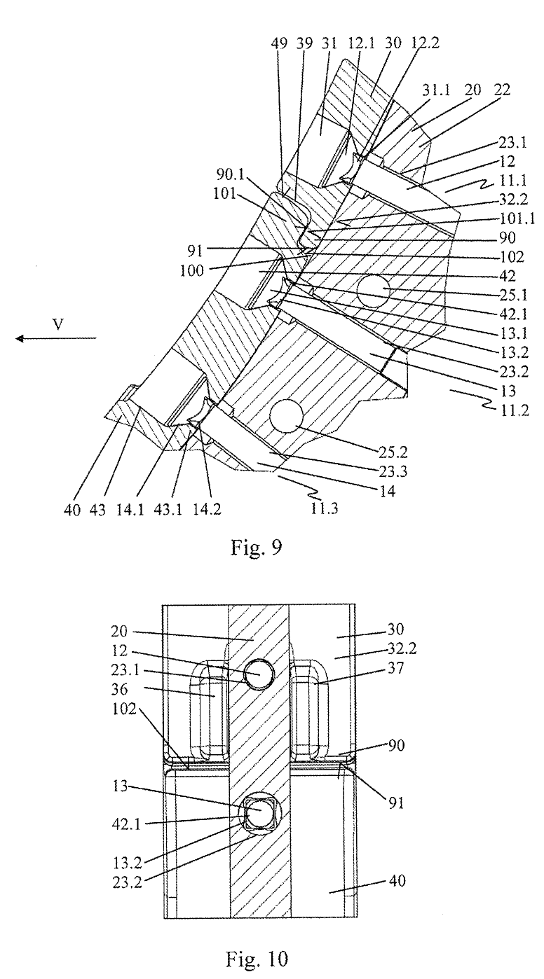

The form-fitting connection is designed such that only a suitably formed first plug attachment 70 can be inserted into the first receptacle 80 and be affixed therein. This allows for encoding so that only guide elements 30 and share tips 40 that are matched to one another can be put together. This can ensure, for example, that only guide elements 30 can be fitted with a share tip 40 that have a greatest thickness 38.2 in their connection region 30.3 that is matched to the share tip 40. For comparable share tips 40 having a different thickness, other guide elements 30 are respectively provided with a different matching largest thickness 38.2. These can then have differently shaped plug attachments 90, 110, as shown in FIGS. 9, 10 and 11, with which they can be affixed in corresponding receptacles 100, 120, of the share tips 40.

FIG. 8 shows the section of the form-fitting connection, shown in FIG. 7, in a partially sectioned rear view. Here, the carrier part 22 of the tine 20 is marked as a section, corresponding to a section line, marked with VIII in FIG. 2. The first plug attachment 70 is inserted into the first receptacle 80 where it is affixed.

The first receptacle 80 is pocket-shaped and molded into the back side of the share tip 40. It has insertion chamfers 83, laterally adjacent to the first covering portion 81, shown in FIG. 7. The first insertion chamfers 83 are here placed in a V-shape with respect to each other, for example, with a 60° opening angle. In the region below the first insertion chamfers 83, blocking pieces 84 are arranged spaced apart. The two blocking pieces 84 are integrally connected to each other via a connecting piece 85 of the first receptacle 80. The first insertion chamfers 83, the blocking pieces 84, and the connecting piece 62.3 form side walls of the first receptacle 80, which rise from the first covering portion 81. On the front face, towards the guide element 30, the first receptacle 80 is opened by a receptacle opening. A release groove can be provided in the first covering portion 81 along the first insertion chamfers 83, the blocking pieces 84, and the connecting piece 85. The release groove forms a rounded transition from the first covering portion 81 to the side walls, reducing tension peaks applied by external forces, compared to a sharp edging. The release groove also serves to receive a burr, as may be present for manufacturing reasons at the edges on the first plug attachment 70 of the guide element 30, held in the receptacle 80.

The first plug attachment 70 is formed as an approximately U-shaped bracket which is connected to the terminal region 30.3 of the guide element 30. It tapers transversely to the tool feed direction V by two first guide surfaces 74, V-shaped at an angle between, toward two spaced apart opposite side parts 71, which are connected to the bridge 72 at the front end of the guide element 30. With the side parts 71, the bridge 72 and the base body of the first plug attachment 70, opposite the bridge, the recess 73 of the plug attachment 70 is enclosed. The first guide surfaces 74 transition into contact surfaces 75 of the two side parts 71. At the end of the first plug attachment 70, the bracket 72 forms a front edge 76. The first guide surfaces 74, the side parts 71, and the front edge 76 form outer side walls of the first plug attachment 70.

In the illustrated assembled state, the first guide surfaces 74 are arranged at a small distance from the first insertion chamfers 83, the contact surfaces 75 are arranged at a small distance from the first blocking pieces 84, and the front edge 76 is arranged at a small distance from the connecting piece 85. The guide element 30 is thus disposed on the side and held rotationally affixed in the first receptacle 80 of the share tip 40. At the same time, the molded-on attachment 82 engages with the recess 73, ensuring a form-fitting blocking between the first plug attachment 70 and the first receptacle 80. This prevents the first plug attachment 70 from sliding out of the first receptacle 80.

The first insertion chamfers 83 and the associated first guide surfaces 74 facilitate joining of the share tip 40 and the guide element 30 during assembly.

FIG. 9 shows the detail, shown in FIG. 7, in a second embodiment of the form-fitting connection. The same components are again designated with the same references.

The second plug attachment 90 is formed as a short attachment, extending across the width of the guide element 30 and facing the carrier part 22 of the tine 20. The second plug attachment 90 abuts against the carrier part 22 with its back side 32.2. The second plug attachment 90 is inserted into the second receptacle 100 of the share tip 40. The second receptacle 100 is covered in the tool feed direction V by a second covering portion 101. The second plug attachment 90 abuts with a second top side 90.1 against a second bottom side 101.1 of the second covering portion 101 and is held in the tool feed direction V by the same. At its free end, the second plug attachment 90 is terminated by a second rounded front edge 91, sloping down towards the tine 20 in the direction of the connection region 30.3 of the guide element 30. The second front edge 91 is held spaced apart from a second contact region 102 of the second receptacle 100.

In the illustrated embodiment, the second plug attachment 100 is not connected with the share tip 40 by a form-fitting connection, acting in the direction of the longitudinal extension of the guide element 30. The guide element 30 can be replaced as required without having to remove the share tip 40 first. The form-fitting connection formed by the second plug attachment 100 and the second covering portion 101 and acting in the direction of the tool feed direction V prevents lifting or bending of the guide element 30 in its connection region 30 and on the second plug attachment 100 itself. Due to the small distance between the terminating edge 49 of the share tip and the front surface 39 of the guide element 30, larger quantities of soil are prevented from passing into the region of the second receptacle 100 and jamming the components against one another. The share tip 40 and the guide element can therefore be separated easily and safely even after a long operating time with correspondingly high wear.

Compared to the form-fitting connection shown in FIGS. 7 and 8, the respective receptacles 80, 100, and the associated plug attachments 90, 110, are designed differently so that the second plug attachment 110 does not fit into the first receptacle 80 and the first plug attachment 90 does not fit into the second receptacle 100. This can allow for an unambiguous assignment of a particular embodiment of a share tip 40 to a corresponding embodiment of a guide element 30. For example, different embodiments of share tips 40 with different material thicknesses in their region facing the guide element 30 can be uniquely matched to associated guide elements 30 with matched greatest thicknesses 38.2 in their connection region 30.3. Guide elements 30 with a different greatest thickness 38.2 cannot be erroneously combined with a non-associated share tip 40, due to the design of their plug attachment 70, 90. This ensures that there are no edges in the region of transition between the share tip 40 and the guide element 30, which are subject to increased wear. Furthermore, it is ensured that the share tip 40 and the guide element 30 have similar service lives so that the maintenance intervals are matched.

FIG. 10 shows the section, shown in FIG. 9, in a Partially sectioned rear view.

The second plug attachment 90 is inserted into the second receptacle 100 of the share tip 40. Due to the small distance between the second front edge 91 of the guide element 30 and the opposite second contact region 102 of the share tip 40 soil is prevented from entering into the second receptacle 100.

The second plug attachment 90 is formed over the entire width of the guide element 30 so that a resilient form-fitting connection is formed in the tool feed direction V. Transversely to the tool feed direction V, the form-fitting connection is not effective. The form-fitting connection also does not block movement of the second plug attachment 90 from the second receptacle in the direction of the guide element 30.

As shown with reference to FIG. 6, opposed crosspieces 36, 37, are arranged to the side of the tine 20 laterally affixing the guide element 30. In combination with the form-fitting connection, formed by the second plug attachment 90 and the second receptacle 100 and acting in the tool feed direction V, the guide element is thus held in the tool feed direction V, as well as transversely thereto, in a form-fitting manner. The second screw connection 11.2 prevents the second plug attachment 90 from being pulled out of the second receptacle. For individual disassembly of the guide element 30, only the second screw connection 11.2 needs to be loosened and the guide element 30 with its second plug attachment 90 pulled out of the second receptacle 100. The share tip 40 can remain mounted.

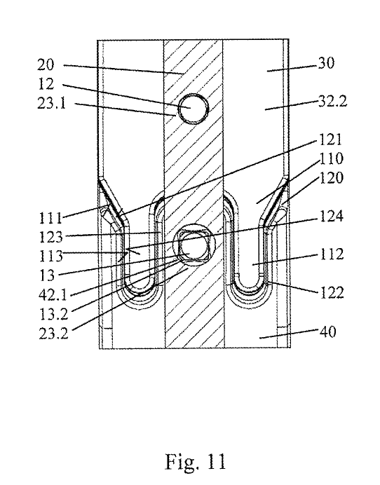

FIG. 11 shows the detail, shown in FIGS. 8 and 10, in a third embodiment of the form-fitting connection.

The third plug attachment 110 is formed by two U-shaped attachments 112, spaced apart and arranged to the side of the tine 20, which are held in two U-shaped recesses 122 in the correspondingly formed third receptacle 120. Similarly, to the first plug attachment 70, the third plug attachment 110 has two V-shaped guide surfaces 111, extending at an angle, which are arranged opposite two corresponding insertion chamfers 121 of the third receptacle 120. The side walls of the U-shaped attachments 112 form contact surfaces 113 which are arranged opposite the blocking portions 124 of the third receptacle 120. A middle crosspiece is formed between the U-shaped recesses 122, through which the second fastening screw 13 of the second screw connection 11.2 is inserted.

Compared to the form-fitting connection shown in FIGS. 9 and 10, formed by the second plug attachment 90 and the second receptacle 100, the form-fitting connection shown in FIG. 11 also blocks lateral movement of the guide element 30 or the share tip 40. Therefore, the crosspieces 36, 37, attached to the side of the tine 20 on the back side 32.2 of the connection region 30.3 of the guide element 30, can be omitted. Compared to the form-fitting connection shown in FIGS. 7 and 8, which, together with the transversely extending bridge 72, encloses the molded-on attachment 82, thus blocking movement of the second plug attachment 90 out of the second receptacle 100, the form-fitting connection shown in FIG. 11 acts only in the tool feed direction V and transversely to the longitudinal extension of the guide element 30 and the share tip 40. In the direction of the longitudinal extension of the guide element 30 and of the share tip 40, the guide element 30 is held only by the first screw connection 11.1 and the share tip 40 is held only by the second and third screw connection 11.2, 11.3. Accordingly, the share tip 40 does not need be detached from the tine 20 for mounting and dismounting of the guide element 30. The third plug attachment 110 can be removed from, and pushed into, the third receptacle 120 after the first attachment screw 12 is removed.

1. A guide element for an agricultural soil-cultivation machine comprising a connection region for arranging the guide element on a share tip, and comprising a first screw connection for attaching the guide element on a carrier, in particular on a tine of the agricultural soil-cultivation machine,
wherein the guide element has varying thickness, at least in regions along the longitudinal extension thereof running from the connection region to a turned-away end region.

2. A guide element according to claim 1, wherein the guide element has its greatest thickness in the connection region, facing the share tip.

3. The guide element according to claim 1, wherein the guide element has its smallest thickness in the end region, facing away from the share tip.

4. The guide element according to claim 1, wherein the thickness of the guide element continuously decreases, starting from the connection region to the end region.

5. The guide element according to claim 1, wherein the thickness of the guide element in its connection region corresponds to the thickness of the share tip associated with the guide element at its end facing the guide element within predetermined tolerances.

6. The guide element according to claim 1, wherein the first screw connection is arranged in the connection region of the guide element and/or that a first screw head of a first fastening screw of the first screw connection is arranged in a first screw receptacle in a countersunk position relative to a deflecting surface of the guide element.

7. The guide element according to claim 1, wherein the guide element can be constructed for its back side to be in contact with the carrier and/or that the guide element has protruding crosspieces on its back side, arranged spaced from each other, and/or that a guide receptacle for the carrier is formed between the crosspieces.

8. A guide element according to claim 7, wherein the crosspieces are arranged in the connection region and/or in the end region of the guide element.

9. A guide element according to claim 7, wherein two crosspieces in each area arranged opposite of one another on both sides of the carrier and/or that the crosspieces have drafts on their sides facing the carrier, such that their mutual distance increases with increasing distance from the back side of the guide element.

10. The guide element according to claim 7 wherein a contact surface is formed between the crosspieces for abutment of the guide element against the carrier and/or that clearances are provided in the form of grooves in the transition from the drafts to the contact surface.

11. The guide element according to claim 7, wherein the crosspieces have outer crosspiece surfaces on their sides facing away from the guide element and that the transitions from the drafts to the outer crosspiece surfaces are rounded.

12. The guide element according to claim 1, wherein the guide element has an attachment, in particular a plug attachment, at the connection region for affixing in a receptacle of the share tip.

13. A guide element according to claim 12, wherein the shape of the attachment of the guide element is designed such that it can be connected only with a share tip that is uniquely associated to the guide element by a receptacle that is adapted to it in its shape.

14. A guide element according to claim 12, wherein the attachment of the guide element is equipped with at least one projection and/or at least one recess for cooperating with a receptacle and/or an attachment of the share tip molded thereto.

15. The guide element according to claim 12, wherein the attachment and the receptacle form a form-fitting connection.

16. The guide element according to claim 1, wherein the guide element is integrally formed on the share tip.

17. The guide element according to claim 1, wherein the front side of the guide element forming the guide surface coils in the region between the end facing the share tip and the end facing away from the share tip.

18. A tool combination with a guide element and a share tip for an agricultural soil-cultivation machine, having a connection region of the guide element for arranging the guide element on a share tip, and having a first screw connection for attaching the guide element on a carrier, in particular on a tine of the agricultural soil-cultivation machine, wherein a thickness of the guide element in the connection region corresponds to a thickness of the share tip at its end, facing the guide element, within predefined tolerances,
wherein the guide element has varying thickness, at least in regions along the longitudinal extension thereof running from the connection region to a turned-away end region.

19. The tool combination according to claim 18, wherein the thickness of the guide element continuously decreases, starting from the connection region to an end region of the guide element, opposite the connection region.

20. The tool combination according to claim 18, wherein the share tip has a receptacle which is covered by a covering portion in the tool feed direction, the guide element has an attachment, in particular a plug attachment, which is held in the receptacle, and that a form-fitting connection is operative in the region of the receptacle between the share tip and the guide element, which is formed by a receptacle and the attachment engaging therewith.

21. The tool combination according to claim 20, wherein the shape of the attachment, in particular the plug attachment, is selected depending on the thickness of the guide element in its end region, and the shape of the receptacle of the share tip is selected depending on the thickness of the share tip at its end facing the guide element, such that the attachment, in particular the plug attachment, and the receptacle are connectable only with identical thickness of the guide element in its connection region and the share tip at its end facing the guide element.

22. The tool combination, according to claim 18, wherein the guide element along its longitudinal extension, preferably in its end region, or otherwise at any point on the front side is concavely shaped in a tool feed direction so that the share tip, along its longitudinal extension at least in a portion facing the guide element, is concavely shaped in the tool feed direction and that the radii of the concavely shaped portions, at least in the connection region of the guide element and the portion of the share tip facing the guide element are identical within manufacturing-related tolerances and/or that the concave portions transition into one another.
